(19) United States
(12) Patent Application Publication
(10) Pub. No.: US 2025/0316999 A1
(43) Pub. Date: Oct. 9, 2025

(54) CHARGER, CHARGING SYSTEM, AND METHOD FOR CONTROLLING TWO OR MORE CHARGERS

(71) Applicant: MAKITA CORPORATION, Anjo-shi (JP)

(72) Inventors: Hidehiro YAMAUCHI, Anjo-shi (JP); Tomoo MURAMATSU, Anjo-shi (JP)

(73) Assignee: MAKITA CORPORATION, Anjo-shi (JP)

(21) Appl. No.: 19/169,410

(22) Filed: Apr. 3, 2025

(30) Foreign Application Priority Data
Apr. 5, 2024 (JP) 2024-061656

(51) Int. Cl. H02J 7/00

(52) U.S. Cl. CPC H02J 7/0071; H02J 7/00032; H02J 7/0013; H02J 7/0045; H02J 7/0047

(57) ABSTRACT

One aspect of the present disclosure provides a charger including a housing, a charging circuit, a communication device, and a control circuit. The control circuit controls the charging circuit so as to put a charging operation of the charging circuit on hold, based on a battery pack being attached to the housing and the communication device having received a first charging notification from a first external charger. The first charging notification is transmitted from the first external charger based on the first external charger transitioning or having transitioned to its charging operation.

### CROSS-REFERENCE TO RELATED APPLICATIONS

This application claims the benefit of Japanese Patent Application No. 2024-061656 filed with the Japan Patent Office on Apr. 5, 2024, the entire disclosure of which is incorporated herein by reference.

### BACKGROUND

The present disclosure relates to charging of a battery pack.

Japanese Patent No. 6699078 discloses a charger capable of charging a battery pack having a nominal capacity of 5 ampere hours or more at a charging rate of 2C or more and 3C or less.

### SUMMARY

In a case where the above-mentioned charger charges a battery pack having a rated capacity of 8 ampere hours at a charging rate of 3C, the charger needs to deliver charging current of 24 amperes to the battery pack. If a charging voltage of 40 volts is required to deliver such charging current to the battery pack, the charger needs to deliver 960 watts (=40 volts×24 amperes) of power to the battery pack. Assuming that the charger has a conversion efficiency of 90% and a power factor of 1, the charger needs to receive approximately 1,100 watts of power. In this case, a magnitude of electric current delivered to the charger from a 100-volt AC commercial power supply in Japan may reach up to 11 amperes.

In general, circuit breakers used in general households in Japan have a capacity of merely 20 amperes. Thus, in situations where (i) the charger is coupled to the same circuit breaker together with at least one additional similar charger, and (ii) two or more battery packs are simultaneously charged by these chargers, the circuit breaker may be tripped. As a result, none of the battery packs may be charged.

In one aspect of the present disclosure, it is desirable that two or more chargers can charge two or more battery packs while reducing electric current flowing through a power supply path to which the two or more chargers are coupled.

In this disclosure, terms such as “first” and “second” are only intended to distinguish elements from one another and are not intended to limit the order or number of elements. Therefore, a first element may be referred to as a second element, and likewise, the second element may be referred to as the first element. In addition, the first element may be provided without the second element, and likewise, the second element may be provided without the first element.

One aspect of the present disclosure provides a charger including a housing, a charging circuit, a communication device, and a control circuit.

The housing is configured such that a battery pack is detachably attached thereto. The charging circuit is in the housing. The charging circuit is configured (i) to receive external power from an external power supply and (ii) to perform a charging operation to charge the battery pack attached to the housing based on the external power. The external power supply is outside the housing. The communication device is configured to communicate with a first external charger. The first external charger is outside the housing. The control circuit is in the housing. The control circuit is configured to control the charging circuit so as to put the charging operation of the charging circuit on hold, based on the battery pack being attached to the housing and the communication device having received a first charging notification from the first external charger. The control circuit is configured to control the charging circuit such that the charging circuit initiates the charging operation, based on the battery pack being attached to the housing and the communication device not having received the first charging notification. The first charging notification is transmitted from the first external charger based on the first external charger transitioning or having transitioned to its charging operation.

In the charger configured as described above, charging of the battery pack is automatically put on hold based on the first external charger transitioning or having transitioned to its charging operation when the battery pack is attached to the housing. As a result, an electric current flowing into the charger from the external power supply is reduced.

The charger can reduce an electric current flowing through a power supply path to which two or more chargers are coupled, which can suppress a circuit breaker from being tripped. Unless the circuit breaker is tripped, it is possible to charge two or more battery packs with two or more chargers.

Another aspect of the present disclosure provides a charging system including two or more chargers. The two or more chargers are electrically coupled to a shared power supply path. Each of the two or more chargers is configured to charge a battery pack. At least one of the two or more chargers is the charger in the above-mentioned one aspect. The shared power supply path is configured to receive external power from an external power supply.

In the charging system configured as described above, it is possible to charge two or more battery packs with the two or more chargers while reducing an electric current flowing through the shared power supply path.

Still another aspect of the present disclosure provides a method for controlling two or more chargers, including:
electrically coupling the two or more chargers to a shared power supply path, the shared power supply path receiving external power from an external power supply;
communicably coupling the two or more chargers to one another;
electrically coupling at least one battery pack to at least one charger of the two or more chargers for charging the at least one battery pack; and
transmitting a charging notification from one of the at least one charger to one or more remaining chargers of the two or more chargers to put charging operations of the one or more remaining chargers on hold.

According to the method as described above, it is possible to charge two or more battery packs with the two or more chargers while reducing an electric current flowing through the shared power supply path.

### BRIEF DESCRIPTION OF THE DRAWINGS

Some example embodiments of the present disclosure will be described hereinafter by way of example with reference to the accompanying drawings, in which:

FIG. 1 is a block diagram showing an overall configuration of a charging system in an embodiment;

FIG. 2 is a perspective view showing respective external appearances of a charger and a battery pack;

FIG. 3 is a block diagram showing a circuit configuration of the charger;

FIG. 4 is a flowchart of a charging permission determination process;

FIG. 5 is a flowchart of a notification process; and

FIG. 6 is a flow chart of a contention avoidance process.

### DETAILED DESCRIPTION OF EXEMPLARY EMBODIMENTS

### 1. Overview of Embodiments

One embodiment may include at least any one of:
Feature 1: a charger;
Feature 2: the charger includes a housing configured such that a battery pack is detachably attached thereto;
Feature 3: the charger includes a charging circuit in the housing;
Feature 4: the charging circuit is configured (i) to receive external power from an external power supply and (ii) to perform a charging operation to charge the battery pack attached to the housing based on the external power;
Feature 5: the external power supply is outside the housing;
Feature 6: the charger includes a communication device configured to communicate with a first external charger;
Feature 7: the first external charger is outside the housing;
Feature 8: the charger includes a control circuit in the housing;
Feature 9: the control circuit is configured (or programmed) to control the charging circuit so as to put the charging operation of the charging circuit on hold (or so as to delay or suspend the charging operation of the charging circuit), based on the battery pack being attached to the housing and the communication device having received a first charging notification from the first external charger;
Feature 10: the control circuit is configured (or programmed) to control the charging circuit such that the charging circuit initiates the charging operation, based on the battery pack being attached to the housing and the communication device not having received the first charging notification; and
Feature 11: the first charging notification is transmitted from the first external charger based on the first external charger transitioning or having transitioned to its charging operation.

In one embodiment including at least Features 1 through 11 (or at least Features 1 through 9 and 11), charging of the battery pack is put on hold based on the first external charger transitioning or having transitioned to its charging operation when the battery pack is attached to the housing.

Such an embodiment can inhibit a large electric current from flowing through a power supply path by reducing an electric current flowing from the external power supply into the charger when the first external charger is transitioning or has transitioned to its charging operation. Therefore, it is possible to inhibit a magnitude of an electric current flowing through the power supply path from exceeding a permissible value and to thereby suppress the power supply path from being shut off by a safety device such as a circuit breaker.

One embodiment may include, in addition to or in place of at least any one of Features 1 through 11, at least any one of:
Feature 12: the communication device is configured to communicate with a second external charger in addition to the first external charger;
Feature 13: the second external charger is (i) distinct from the first charger and (ii) outside the housing;
Feature 14: the control circuit is configured (or programmed) to control the charging circuit so as to put the charging operation of the charging circuit on hold, based on the battery pack being attached to the housing and the communication device having received the first charging notification or a second charging notification;
Feature 15: the control circuit is configured (or programmed) to control the charging circuit such that the charging circuit initiates the charging operation, based on the battery pack being attached to the housing and the communication device having received neither the first charging notification nor the second charging notification; and
Feature 16: the second charging notification is transmitted from the second external charger based on the second external charger transitioning or having transitioned to its charging operation.

In one embodiment including at least Features 1 through 16, it is possible to put charging of the battery pack on hold based on the first external charger or the second external charger transitioning or having transitioned to its charging operation when the battery pack is attached to the housing.

In such an embodiment, even when the first external charger and the second external charger, in addition to the charger, are coupled to the power supply path, it is possible to inhibit a large electric current from flowing through the power supply path due to the charger charging the battery pack.

One embodiment may include, in addition to or in place of at least any one of Features 1 through 16, at least any one of:
Feature 17: the control circuit is configured (or programmed) to transmit a third charging notification from the communication device to the second external charger based on the communication device having received the first charging notification; and
Feature 18: the second external charger is configured to put its charging operation on hold based on a receipt of the third charging notification.

In one embodiment including at least Features 1 through 18, it is possible to put not only the charging operation of the charging circuit but also the charging operation of the second external charger on hold when the first external charger is transitioning or has transitioned to its charging operation. As a result, it is possible to further reduce an electric current flowing through the power supply path.

One embodiment may include, in addition to or in place of at least any one of Features 1 through 18, at least any one of:
Feature 19: the control circuit is configured (or programmed) to transmit a third charging notification from the communication device to the first external charger and to the second external charger when the control circuit controls the charging circuit such that the charging circuit initiates the charging operation; and
Feature 20: each of the first external charger and the second external charger is configured to put its charging operation on hold based on a receipt of the third charging notification.

In one embodiment including at least Features 1 through 16, 19, and 20, it is possible to put both the charging operation of the first external charger and the charging operation of the second external charger on hold when the control circuit controls the charging circuit such that the charging circuit initiates the charging operation, resulting further reduction in an electric current flowing through the power supply path.

One embodiment may include, in addition to or in place of at least any one of Features 1 through 20, at least any one of:
Feature 21: the control circuit is configured (or programmed) (i) to transmit the third charging notification from the communication device to the first external charger and to the second external charger and (ii) to control the charging circuit so as to keep the charging operation of the charging circuit on hold, based on the battery pack being attached to the housing and the communication device having received neither the first charging notification nor the second charging notification;
Feature 22: the control circuit is configured (or programmed) to transmit a stop notification from the communication device to the first external charger based on the communication device having received the first charging notification by a lapse of a preset time period when the charging operation of the charging circuit is kept on hold; and
Feature 23: the first external charger is configured to transition to its charging operation based on a receipt of the stop notification.

In one embodiment including at least Features 1 through 16 and 19 through 23, it is possible to prioritize the charging operation of the first external charger over the charging operation of the charging circuit.

One embodiment may include, in addition to or in place of at least any one of Features 1 through 23,
Feature 24: the control circuit is configured (or programmed) to control the charging circuit such that the charging circuit initiates the charging operation, based on the communication device having received neither the first charging notification nor the second charging notification by the lapse of the preset time period.

In one embodiment including at least Features 1 through 16 and 19 through 24, the charging circuit alone can perform the charging operation when neither the first external charger nor the second external charger is performing their respective charging operations.

One embodiment may include, in addition to or in place of at least any one of Features 1 through 24, at least any one of:
Feature 25: the charger includes a notification device configured to notify a user of the charger that the charging operation of the charging circuit is on hold; and
Feature 26: the control circuit is configured (or programmed) to activate the notification device based on the control circuit controlling the charging circuit so as to put the charging operation of the charging circuit on hold.

According to one embodiment including at least Features 1 through 11, 25, and 26, the user can recognize that the charger operates properly when the battery pack is attached to the housing but charging of the battery pack is not initiated.

One embodiment may include, in addition to or in place of at least any one of Features 1 through 26,
Feature 27: the control circuit is configured (or programmed) to control the charging circuit such that the charging circuit initiates the charging operation based on the communication device not receiving the first charging notification when the charging operation of the charging circuit is on hold.

According to one embodiment including Features 1 through 11 and 27, the control circuit can quickly initiate the charging operation of the charging circuit after the first external charger terminates its charging operation. Therefore, the usability of the charger can be improved because charging of the battery pack is automatically initiated without the user performing any manual operation.

In one embodiment, the control circuit may be integrated into a single electronic unit or into a single electronic device or into a single circuit board.

In one embodiment, the control circuit may be a combination of (i) two or more electronic circuits, (ii) two or more electronic units, or (iii) two or more electronic devices, each of which is separately disposed inside the housing.

In one embodiment, the control circuit may include a microcomputer (or a microcontroller or a microprocessor,), a wired logic, a graphics processing unit (GPU), an application specific integrated circuit (ASIC), an application specific general product (ASSP), a programmable logic device (such as a field programmable gate array (FPGA)), a discrete electronic component, and/or a combination of the foregoing.

One embodiment may include at least any one of:
Feature 28: a charging system;
Feature 29: the charging system includes two or more chargers electrically coupled to a shared power supply path;
Feature 30: each of the two or more chargers is configured to charge a battery pack;
Feature 31: at least one of the two or more chargers is a charger including at least Features 1 through 4, 6, and 8 through 10 (or at least Features 1 through 4 and 6 through 9); and
Feature 32: the shared power supply path is configured to receive external power from an external power supply.

According to one embodiment including at least Features 28 through 32, it is possible to charge two or more battery packs with the two or more chargers while reducing an electric current flowing through the shared power supply path.

One embodiment may include at least any one of:
Feature 33: a method for controlling two or more chargers;
Feature 34: the method includes electrically coupling the two or more chargers to a shared power supply path;
Feature 35: the shared power supply path receives external power from an external power supply;
Feature 36: the method includes communicably coupling the two or more chargers to one another;
Feature 37: the method includes electrically coupling at least one battery pack to at least one charger of the two or more chargers for charging the at least one battery pack; and
Feature 38: the method includes transmitting a charging notification from one of the at least one charger to one or more remaining chargers of the two or more chargers to put charging operations of the one or more remaining chargers on hold.

According to one embodiment including at least Features 33 through 38, it is possible to charge two or more battery packs with the two or more chargers while reducing an electric current flowing through the shared power supply path.

In one embodiment, Features 1 through 38 may be combined in any combinations.

In one embodiment, any of Features 1 through 38 may be excluded.

### 2. Specific Exemplary Embodiments

Specific exemplary embodiments are described below. The specific exemplary embodiments exemplify a charging system 10 as described below.

### 2-1. Overall Configuration of Charging System

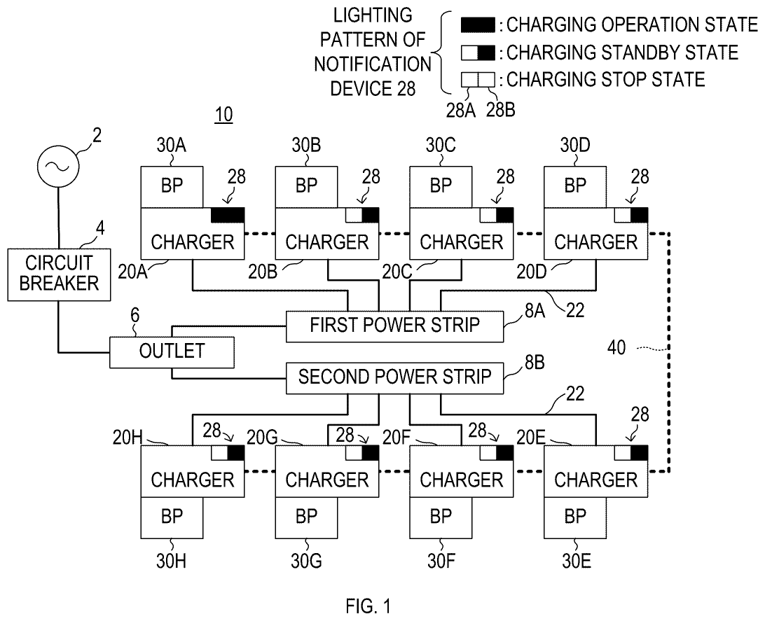

As shown in FIG. 1, the charging system 10 includes first through eighth chargers 20A through 20H. In another embodiment, any one, two, three, four, five, or six of the first through eighth chargers 20A through 20H may be eliminated from the charging system 10. In still another embodiment, at least one similar charger may be added to the charging system 10.

The first through fourth chargers 20A through 20D are coupled to a first power strip 8A. The fifth through eighth chargers 20E through 20H are coupled to a second power strip 8B. The first and second power strips 8A and 8B are coupled to an outlet (or a socket) 6. The outlet 6 is coupled to an external power supply 2 via a circuit breaker 4, and receives alternating power (AC) having AC 100 to 130 volts or AC 220 to 240 volts from the external power supply 2. The external power supply 2 is, but not limited to, a commercial power supply (or a general-purpose alternating power supply). In another embodiment, the external power supply 2 may be an electric generator or a large-capacity battery.

The first through eighth chargers 20A through 20H are sequentially coupled from the first charger 20A to the eighth charger 20H via a communication line 40 to form a daisy chain. More specifically, the first charger 20A is coupled to the second charger 20B via the communication line 40 so as to communicate with the second charger 20B. Each of the second through seventh chargers 20B through 20G is coupled to previous and next chargers via the communication line 40 so as to communicate with the previous and next chargers of the charger. The eighth charger 20H is coupled to the seventh charger 20G via the communication line 40 so as to communicate with the seventh charger 20G. In another embodiment, the first through eighth chargers 20A through 20H may be communicably coupled to one another via wireless communication instead of the communication line 40.

Priority for initiating charging is assigned to the first through eighth chargers 20A through 20H. Not for limitation, but for simplification of description, priorities are assigned in order of the first charger 20A to the eighth charger 20H in the present embodiment. In other words, the highest priority is assigned to the first charger 20A and the lowest priority is assigned to the eighth charger 20H.

The first through eighth chargers 20A through 20H are configured to charge first through eighth battery packs (BPs) 30A through 30H, respectively. The first through eighth battery packs 30A through 30H are configured to be detachably attached to any electric work machine and to deliver direct power (DC) to the electric work machine.

The first through eighth chargers 20A through 20H have an identical structure. Therefore, in the following, each of the first through eighth chargers 20A through 20H is referred to as a “charger 20” without being individually distinguished. The first through eighth battery packs 30A through 30H have an identical structure. Therefore, in the following, each of the first through eighth battery packs 30A through 30H is referred to as a “battery pack 30” without being individually distinguished.

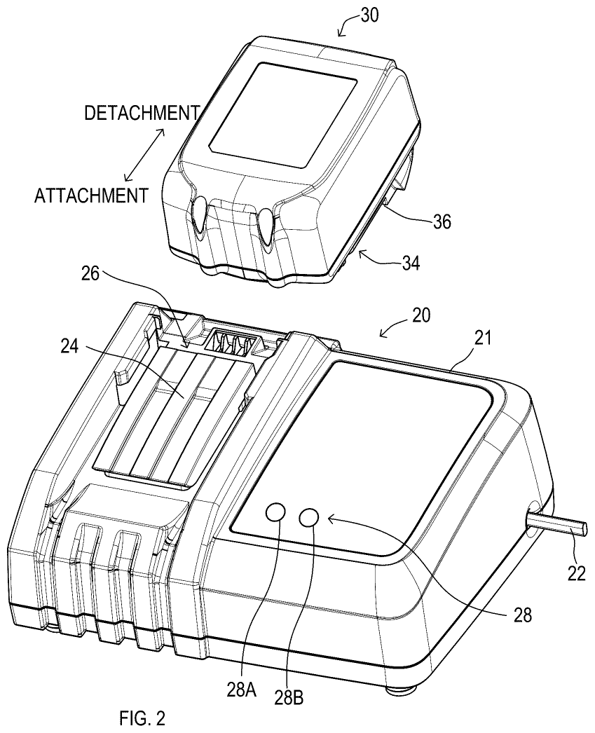

As shown in FIG. 2, the battery pack 30 is configured to be detachably attached to the charger 20. The battery pack 30 houses a battery (not shown) therein. The battery includes first through third battery cells coupled in series. Specifically, the first battery cell includes its negative electrode that serves as a negative electrode of the battery. The second battery cell includes (i) its negative electrode coupled with a positive electrode of the first battery cell and (ii) its positive electrode coupled with a negative electrode of the third battery cell. The third battery cell includes its positive electrode that serves as a positive electrode of the battery.

The battery pack 30 includes a first attachment part 34 configured such that the battery pack 30 is detachably attached to the charger 20 or the electric work machine. The first attachment part 34 includes a first terminal part 36 configured to be electrically coupled to the charger 20 or the electric work machine.

The first terminal part 36 includes a first positive terminal, a first negative terminal, a first cell voltage output terminal, a second cell voltage output terminal, and a signal output terminal, which are not shown.

The first positive terminal is coupled to the positive electrode of the battery (that is, the positive electrode of the third battery cell). The first negative terminal is coupled to the negative electrode of the battery (that is, the negative electrode of the first battery cell). The first cell voltage output terminal is coupled to the positive electrode of the first battery cell and to the negative electrode of the second battery cell. The second cell voltage output terminal is coupled to the positive electrode of the second battery cell and to the negative electrode of the third battery cell. The signal output terminal is configured to output a state signal. The state signal varies in association with the state of the battery pack 30. Examples of the state of the battery pack 30 includes an operating state (i.e., an active state or an inactive state) of a control circuit of the battery pack 30, and the temperature of the battery (or the temperature of any of the first through third battery cells).

The charger 20 includes a housing 21. The housing 21 includes a second attachment part 24 configured such that the first attachment part 34 of the battery pack 30 is detachably attached thereto. The second attachment part 24 includes a second terminal part 26 configured to be electrically coupled to the first terminal part 36 of the battery pack 30.

The housing 21 also includes a power cord 22. The power cord 22 is configured (i) to be detachably coupled to the outlet 6, the first power strip 8A, or the second power strip 8B and (ii) to receive the alternating power from the outlet 6, the first power strip 8A, or the second power strip 8B.

The housing 21 further includes a notification device 28. The notification device 28 is configured to indicate a state of the charger 20. Specifically, the notification device 28 includes a first display lamp 28A and a second display lamp 28B. Each of the first display lamp 28A and the second display lamp 28B is, but not limited to, a light-emitting diode (LED). The first display lamp 28A and/or the second display lamp 28B may be any kind of light source other than an LED. In another embodiment, the notification device 28 may include a liquid-crystal display (LCD) and/or a seven-segment display, in addition to or in place of the first display lamp 28A and/or the second display lamp 28B. In still another embodiment, the notification device 28 may include a speaker, in addition to or in place of the first display lamp 28A and/or the second display lamp 28B. In this case, the notification device 28 may be configured to output sound that corresponds to the state of the charger 20.

Referring again to FIG. 1, a lighting pattern of the notification device 28 is exemplified. As shown in FIG. 1, when both the first and second display lamps 28A and 28B are ON, the charger 20 is in a charging operation state in which the charger 20 is charging the battery pack 30. When the first display lamp 28A is OFF and the second display lamp 28B is ON, the charger 20 is in a charging standby state in which the charger 20 is waiting to initiate charging the battery pack 30. When both the first and second display lamps 28A and 28B are OFF, the charger 20 is in a charging stop state in which the battery pack 30 is not attached to the charger 20, or charging of the battery pack 30 is completed.

In another embodiment, the charging standby state of the charger 20 may be indicated when the first display lamp 28A is ON and the second display lamp 28B is OFF. In still another embodiment, a state of the charger 20 may be indicated by turning on or blinking either the first display lamp 28A or the second display lamp 28B. In still another embodiment, a state of the charger 20 may be indicated by changing light color of either or both the first display lamp 28A and the second display lamp 28B. In still another embodiment, the charger 20 may be provided with the LCD and/or the seven-segment display, and text or graphics corresponding to the state of the charger 20 may be displayed on the LCD and/or the seven-segment display.

### 2-2. Circuit Configuration of Charger

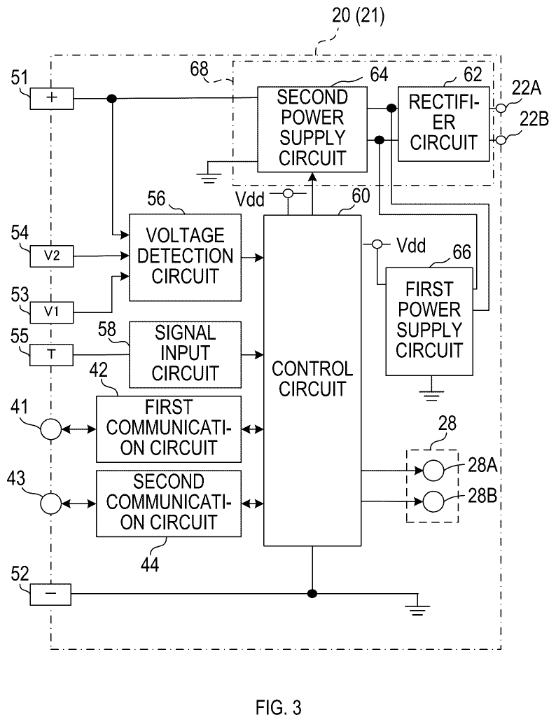

As shown in FIG. 3, the charger 20 (more specifically, the housing 21) includes a second positive terminal 51, a second negative terminal 52, a first cell voltage input terminal 53, a second cell voltage input terminal 54, and a signal input terminal 55. These terminals are disposed on the second terminal part 26.

The second positive terminal 51 is configured to be detachably coupled to the first positive terminal of the battery pack 30. The second negative terminal 52 is configured to be detachably coupled to the first negative terminal of the battery pack 30. The second negative terminal 52 is coupled to a ground of the charger 20. The ground serves as a reference potential of various electronic circuits in the charger 20. The first cell voltage input terminal 53 is configured to be detachably coupled to the first cell voltage output terminal of the battery pack 30. The second cell voltage input terminal 54 is configured to be detachably coupled to the second cell voltage output terminal of the battery pack 30. The signal input terminal 55 is configured to be detachably coupled to the signal output terminal of the battery pack 30.

In addition to the above-described terminals disposed on the second terminal part 26, the charger 20 (more specifically, the housing 21) includes first and second communication terminals 41 and 43. The first communication terminal 41 is configured to be coupled via the communication line 41 to a charger having a higher priority (hereinafter, referred to as a “higher-order charger”) than the charger 20 among the first through eighth chargers 20A through 20H. The second communication terminal 43 is configured to be coupled via the communication line 41 to a charger having a lower priority (hereinafter, referred to as a “lower-order charger”) than the charger 20 among the first through eighth chargers 20A through 20H.

The charger 20 also includes first and second power supply terminals 22A and 22B. The first and second power supply terminals 22A and 22B are configured to receive an alternating current from the commercial power supply 2 via the power code 22.

The charger 20 further includes a first communication circuit 42, a second communication circuit 44, a voltage detection circuit 56, a signal input circuit 58, a control circuit 60, a first power supply circuit 66, and a charging circuit 68. These circuits are housed in the housing 21.

The first communication circuit 42 is configured to perform serial communication with the second communication circuit 44 of the higher-order charger via the communication line 40 and the first communication terminal 41. The first communication circuit 42 receives a first charging notification or a first stop notification from the higher-order charger. The first charging notification is transmitted from the higher-order charger in response to the higher-order charger transitioning or having transitioned to its charging operation. The first stop notification is transmitted from the higher-order charger in response to the higher-order charger being in the charging standby state or the charging stop state.

The second communication circuit 44 is configured to perform serial communication with the first communication circuit 42 of the lower-order charger via the communication line 40 and the second communication terminal 43. The second communication circuit 44 receives a second charging notification or a second stop notification from the lower-order charger. The second charging notification is transmitted from the lower-order charger in response to the lower-order charger transitioning or having transitioned to its charging operation. The second charging notification is a communication signal having the same form as that of the first charging notification. The second stop notification is transmitted from the lower-order charger in response to the lower-order charger being in the charging standby state or the charging stop state. The second stop notification is a communication signal having the same form as that of the first stop notification.

Each of the first communication circuit 42 and the second communication circuit 44 may be any kind of serial communication device, specifically, may be a clock-synchronous serial communication device or a clock-asynchronous serial communication device, and more specifically, may be a universal asynchronous receiver-transmitter (UART). In another embodiment, the first communication circuit 42 and/or the second communication circuit 44 may be configured to perform wireless communication with the second communication circuit 44 of the higher-order charger and/or the first communication circuit 42 of the lower-order charger, respectively, without the communication line 40.

The voltage detection circuit 56 is configured (i) to detect a voltage value of the battery and individual voltage values of the first through third battery cells based on the respective voltages of the second positive terminal 51, the first cell voltage input terminal 53, and the second cell voltage input terminal 54 and (ii) to transmit these voltage values to the control circuit 60 via serial communication.

The signal input circuit 58 is configured (i) to receive the state signal via the signal input terminal 55 and (ii) to deliver the received state signal to the control circuit 60. The signal input circuit 58 may include a filter that removes a noise from the received state signal.

The first power supply circuit 66 is configured (i) to receive a rectified current from the charging circuit 68 and (ii) to generate a power supply voltage Vdd based on the rectified current. The power supply voltage Vdd is a fixed direct voltage (for example, DC 5 volts), and is supplied to various electronic circuits in the charger 20 including the control circuit 60 and the first and second communication circuits 42 and 44.

The charging circuit 68 is configured to perform a charging operation to charge the battery pack 30 based on the alternating power received from the commercial power supply 2. Specifically, the charging circuit 68 includes a rectifier circuit 62 and a second power supply circuit 64. The rectifier circuit 62 is configured (i) to full-wave rectify or half-wave rectify the alternating current received via the first and second power supply terminals 22A and 22B and (ii) to deliver the rectified current to the first power supply circuit 66 and to the second power supply circuit 64. The second power supply circuit 64 is configured to generate a charging current and a charging voltage for charging the battery pack 30, based on the rectified current. The charging current is a direct current, and the charging voltage is a direct voltage. The charging current and the charging voltage are supplied to the battery pack 30 via the second positive terminal 51 and the second negative terminal 52.

The control circuit 60 is, but not limited to, a microcomputer that includes a central processing unit (CPU), a memory device (including a ROM and a RAM, optionally a flash memory), an input/output (I/O) port, a serial communication interface, a digital-to-analog converter, and an analog-to-digital converter. In another embodiment, the control circuit 60 may include an additional microcomputer. In still another embodiment, the control circuit 60 may include, in addition to or in place of the microcomputer, a logic circuit (or a wired logic connection) including two or more electronic components. In still another embodiment, the control circuit 60 may include a GPU, an ASIC, an ASSP, and/or a PLD in addition to or in place of the microcomputer.

The control circuit 60 is configured (or programmed) (i) to receive the state signal via the signal input circuit 58 and (ii) to detect, based on the received state signal, that the battery pack 30 is attached to the charger 20 (more specifically, the housing 21).

The control circuit 60 is also configured (or programmed) to control the charging circuit 68, specifically, the second power supply circuit 64. The control circuit 60 may be configured (or programmed) to control the second power supply circuit 64 such that the second power supply circuit 64 generates the charging current having a magnitude that corresponds to the voltage value of the battery, the individual voltage values of the first through third battery cells, and the state signal.

The control circuit 60 is also configured (or programmed) to individually turn on or off the first and second display lamps 28A and 28B.

The control circuit 60 is further configured (or programmed) (i) to perform serial communication with a higher-order charger via the first communication circuit 42 and (ii) to perform serial communication with a lower-order charger via the second communication circuit 44. Specifically, the control circuit 60 is configured (or programmed) (i) to recognize the respective states of a higher-order charger and a lower-order charger via the first communication circuit 42 and the second communication circuit 44 before initiating charging of the battery pack 30 and (ii) to transition the charger 20 to the charging standby state in response to the higher-order charger or the lower-order charger being in the charging operation state.

More specifically, the control circuit 60 is configured (or programmed) to execute various processes described below.

### 2-3. Various Processes executed by Control Circuit

### 2-3-1. Charging Permission Determination Process

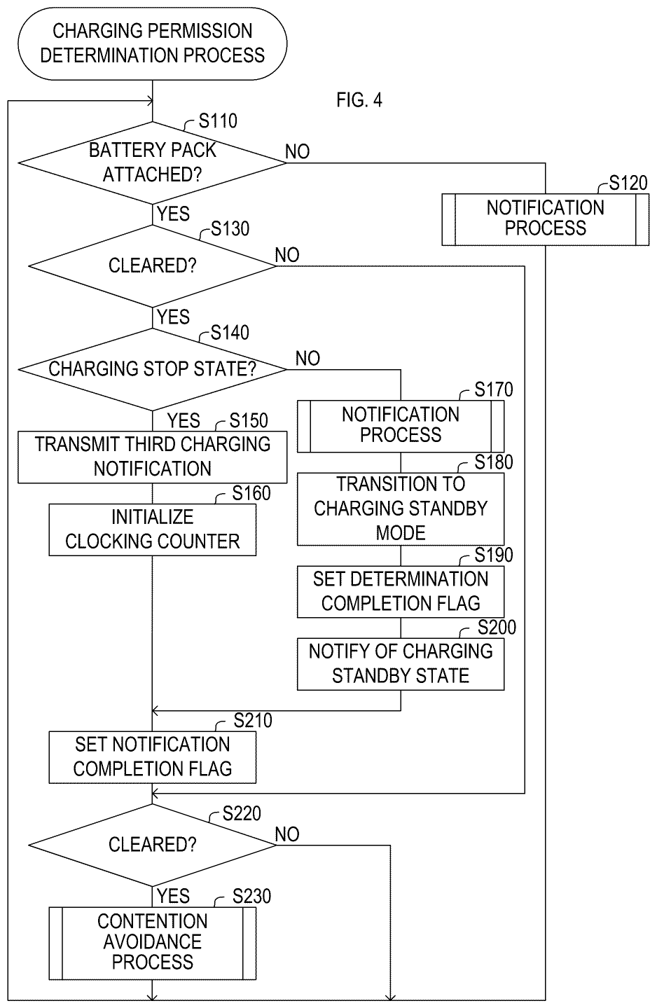

The control circuit 60 is configured (or programmed) to, during its operation, repeatedly execute the charging permission determination process shown in FIG. 4.

As shown in FIG. 4, in the charging permission determination process, the control circuit 60 first, in S110 (S represents a step), determines whether the battery pack 30 is attached to the second attachment part 24.

If the battery pack 30 is not attached to the second attachment part 24 (S110: NO), the control circuit 60 proceeds to S120 to execute a notification process which is described later. Upon completion of the notification process, the control circuit 60 returns to S110.

In S110, if the battery pack 30 is attached to the second attachment part 24 (S110: YES), the control circuit 60 proceeds to S130 to determine whether a notification completion flag is cleared. The notification completion flag is cleared at the time when the battery pack 30 is attached to the second attachment part 24.

In S130, if the notification completion flag is cleared (S130: YES), the control circuit 60 proceeds to S140 to determine whether the higher-order charger and the lower-order charger are in their respective charging stop states. Specifically, the control circuit 60 determines whether the first communication circuit 42 and the second communication circuit 44 have received the first stop notification and the second stop notification, respectively.

If the higher-order charger and the lower-order charger are in their respective charging stop states (S140: YES), the control circuit 60 proceeds to S150. In S150, the control circuit 60 (i) transmits a third charging notification from the first communication circuit 42 to the higher-order charger and (ii) transmits the third charging notification from the second communication circuit 44 to the lower-order charger. The third charging notification is a communication signal (i) having the same form as that of the first charging notification and (ii) indicating that the charger 20 is in the charging operation state.

In subsequent S160, the control circuit 60 initializes a clocking counter and proceeds to S210. The clocking counter is a software counter for counting an elapsed time Tx after the control circuit 60 recognizes that the higher-order charger and the lower-order charger are in their respective charging stop states. In another embodiment, the clocking counter may be a hardware counter.

In S140, if the higher-order charger or the lower-order charger is not in its charging stop state (S140: NO), the control circuit 60 proceeds to S170 to execute the later-described notification process.

In subsequent S180, the control circuit 60 transitions to a charging standby mode. In the charging standby mode, the control circuit 60 controls the charging circuit 68 so as to put the charging operation of the charging circuit 68 on hold to thereby transition the charger 20 to its charging standby state.

In subsequent S190, the control circuit 60 sets a determination completion flag. The determination completion flag is cleared at the time when the battery pack 30 is attached to the second attachment part 24.

In subsequent S200, the control circuit 60 turns on the second display lamp 28B to notify the user of the charger 20 that the charger 20 is in the charging standby state.

In subsequent S210, the control circuit 60 sets the notification completion flag and proceeds to S220.

In S220, the control circuit 60 determines whether the determination completion flag is cleared. If the determination completion flag is set (S220: NO), the control circuit 60 returns to S110.

If the determination completion flag is cleared (S220: YES), the control circuit 60 proceeds to S230 to execute a later-described contention avoidance process, and then returns to S110.

### 2-3-2. Notification Process

The notification process executed in S120 and S170 is described below.

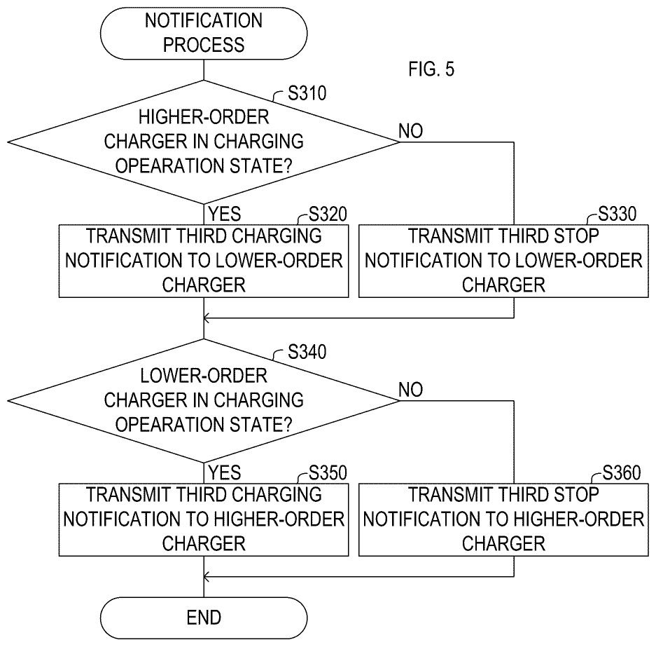

As shown in FIG. 5, in the notification process, the control circuit 60 determines in S310 whether the higher-order charger is in its charging operation state. Specifically, the control circuit 60 determines whether the first communication circuit 42 has received the first charging notification.

If the higher-order charger is its charging operation state (S310: YES), the control circuit 60 proceeds to S320 to transmit the third charging notification from the second communication circuit 44 to the lower-order charger, and then proceeds to S340.

If the higher-order charger is not in its charging operation state (S310: NO), the control circuit 60 proceeds to S330 to transmit a third stop notification from the second communication circuit 44 to the lower-order charger, and then proceeds to S340. The third stop notification is a communication signal (i) having the same form as that of the first stop notification and (ii) indicating that the charger 20 is in its charging standby state or its charging stop state.

In S340, the control circuit 60 determines whether the lower-order charger is in its charging operation state. Specifically, the control circuit 60 determines whether the second communication circuit 44 has received the second charging notification. If the lower-order charger is in its charging operation state (S340: YES), the control circuit 60 proceeds to S350 to transmit the third charging notification from the first communication circuit 42 to the higher-order charger, and then terminates the notification process.

If the lower-order charger is not in its charging operation state (S340: NO), the control circuit 60 proceeds to S360 to transmit the third stop notification from the first communication circuit 42 to the higher-order charger, and then terminates the notification process.

With such a notification process, when any one of the first through eighth chargers 20A through 20H transitions to the charging operation state, the third charging notification is transmitted from the charger to the higher-order charger and to the lower-order charger. Therefore, remaining chargers recognize that another charger in the charging system 10 is in the charging operation state, and wait to transition to their respective charging operation states.

### 2-3-3. Contention Avoidance Process

The contention avoidance process executed in S230 is described below. The contention avoidance process is executed in order to avoid an event to occur where the charger 20 transitions to its charging operation state at the same time as that the higher-order charger and/or the lower-order charger transition(s) to their respective charging operation states. Such an event may occur (i) when the battery pack 30 is attached to the charger 20 powered on at the same time as that other battery packs or another battery pack are/is attached to the higher-order charger powered on and/or to the lower-order charger powered on, or (ii) when the charger 20 is powered on with the battery pack 30 attached thereto at the same time as that the higher-order charger and/or the lower-order charger are/is powered on with other battery packs or another battery pack attached thereto.

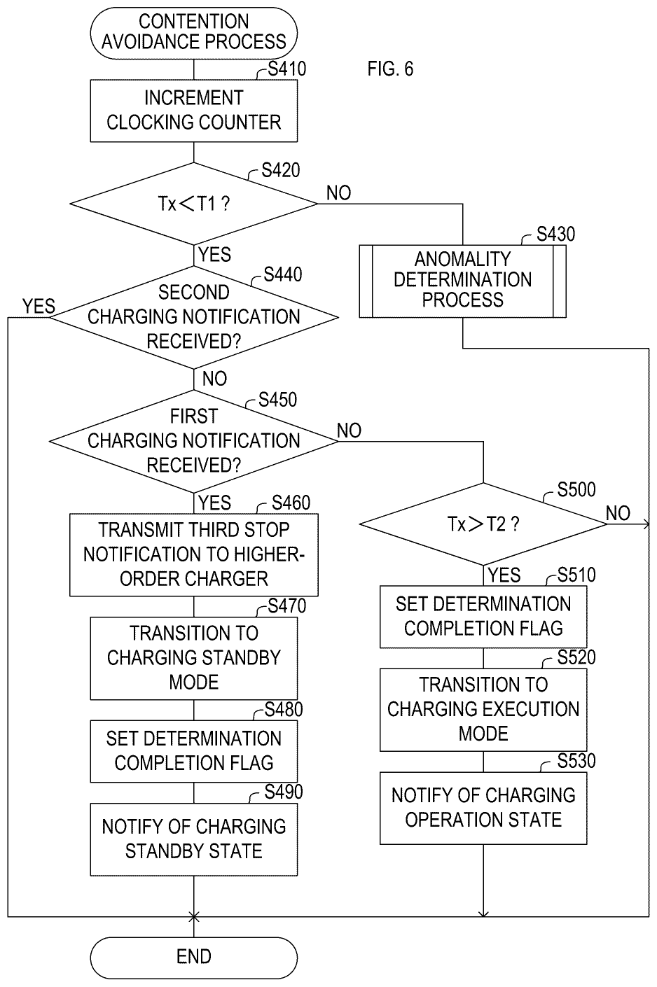

As shown in FIG. 6, in the contention avoidance process, the control circuit 60 increments the clocking counter in S410. As a result, the elapsed time Tx is incremented.

In subsequent S420, the control circuit 60 determines whether the elapsed time Tx is less than a first preset time T1. The first preset time T1 is any time period that cannot be reached if the charger 20 operates properly.

If the elapsed time Tx is greater than or equal to the first preset time T1 (S420: NO), the control circuit 60 proceeds to S430 to execute an anomality determination process, and then terminates the contention avoidance process. In the anomality determination process, the control circuit 60 performs an error display of blinking the first and second display lamps 28A and 28B or executes the contention avoidance process again, for example.

In S420, if the elapsed time Tl is less than the first preset time TI (S420: YES), the control circuit 60 proceeds to S440 to determine whether the second communication circuit 44 has received the second charging notification. If the second communication circuit 44 has received the second charging notification (S440: YES), the control circuit 60 terminates the contention avoidance process.

If the second communication circuit 44 has not received the second charging notification (S440: NO), the control circuit 60 proceeds to S450 to determine whether the first communication circuit 42 has received the first charging notification. If the first communication circuit 42 has received the first charging notification (S450: YES), the control circuit 60 proceeds to S460 to transmit the third stop notification from the first communication circuit 42 to the higher-order charger, thereby notifying the higher-order charger that the charger 20 is in its charging stop state.

In subsequent S470, the control circuit 60 transitions to the charging standby mode. In subsequent S480, the control circuit 60 sets the determination completion flag, and then proceeds to S490. In S490, the control circuit 60 turns on the second display lamp 28B to notify the user that the charger 20 is in its charging standby state, and then terminates the contention avoidance process.

In S450, if the first communication circuit 42 has not received the first charging notification (S450: NO), the control circuit 60 proceeds to S500 to determine whether the elapsed time Tx is greater than a second preset time T2. The second preset time T2 is any time period shorter than the first preset time T1.

If the elapsed time Tx is less than or equal to the second preset time T2 (S500: NO), the control circuit 60 terminates the contention avoidance process.

If the elapsed time Tx is greater than the second preset time T2 (S500: YES), the control circuit 60 proceeds to S510 to set the determination completion flag, and then proceeds to S520.

In S520, the control circuit 60 transitions to a charging execution mode.

In the charging execution mode, the control circuit 60 controls the charging circuit 68 such that the charging circuit 68 initiates the charging operation. As a result, charging of the battery pack 30 is initiated.

In subsequent S530, the control circuit 60 turns on the first and second display lamps 28A and 28B to notify the user that the charger 20 is in its charging operation state, and then terminates the contention avoidance process.

### 2-4. Effects of Embodiment

In the charging system 10 according to the present embodiment, the first through eighth chargers 20A through 20H are coupled to a shared power supply path to which the alternating power from the external power supply 2 is delivered via the circuit breaker 4. The first through eighth chargers 20A through 20H have the identical configuration, and the control circuit 60 housed in each housing 21 executes the above-described charging permission determination process.

In the charging permission determination process, when the battery pack 30 is attached to the housing 21, it is determined whether the first charging notification or the second charging notification has been received by the first communication circuit 42 or the second communication circuit 44. If the first charging notification or the second charging notification has been received, charging of the battery pack 30 is put on hold. If the first charging notification and the second charging notification have not been received, charging of the battery pack 30 is initiated.

Therefore, one charger alone, among the first through eighth chargers 20A through 20H, is permitted to charge the battery pack 30, and an electric current flowing through the shared power supply path can be reduced. Therefore, it is possible to inhibit the magnitude of the electric current flowing through the shared power supply path from exceeding the capacity of the circuit breaker 4, suppressing the circuit breaker 4 from tripping. As a result, the chances of the shared power supply path to be shut off can be reduced.

In addition, priority for charging is assigned to the first through eighth chargers 20A through 20H. If two or more chargers transition to their respective charging operation states almost at the same time to initiate charging, the charger having the highest priority alone is permitted to perform the charging operation by the contention avoidance process, while the other chargers are put in their respective charging standby states.

Therefore, according to the charging system 10, it is possible to more appropriately limit a charger that charges the battery pack 30, and it is possible to suppress the circuit breaker 4 from tripping, and also to suppress all the first through eighth chargers 20A through 20H from being unable to perform charging of the battery packs 30A through 30H.

In addition, as described above, because the charger 20 that has waited for charging due to contention with other chargers notifies via the notification device 28 that the charger 20 is in the charging standby state, the user can wait until charging of the battery pack 30 is initiated. Therefore, according to the charger 20 of the present embodiment, it is possible not only to suppress the circuit breaker 4 from tripping, but also to suppress the usability for the user from deteriorating.

### 2-5. Correspondence between Terms

In the present embodiment, the communication device in the overview of embodiments is exemplified as a combination of the first communication circuit 42 with the second communication circuit 44. The first external charger in the overview of embodiments is exemplified as the higher-order charger. The second external charger in the overview of embodiments is exemplified as the lower-order charger. The stop notification in the overview of embodiments is exemplified as the third stop notification. The preset time period in the overview of embodiments is exemplified as the second preset time T2.

### 2-6. Other Embodiments

Although the embodiment of the present disclosure has been described above, the present disclosure is not limited to the above-described embodiment, and various modifications may be made.

Each of the first through eighth chargers 20A through 20H may be configured to transmit a signal including priority identification information.

In this case, a charger that has received the signal may detect that information has been received from a higher-order charger or a lower-order charger, based on the identification information included in the signal.

Thus, it is not necessary to couple the first through eighth chargers 20A through 20H to one another according to the priority via the communication line 40, and the first through eighth chargers 20A through 20H can be coupled to a shared bus in place of the communication line 40. Alternatively, the first through eighth chargers 20A through 20H may be coupled to one another via a wireless communication path.

In the present embodiment, the first through eighth chargers 20A through 20H are all coupled to one another via the communication line 40. Meanwhile, for example, the first through fourth chargers 20A through 20D coupled to the first power strip 8A may be coupled to one another via the communication line 40, and the fifth through eighth chargers 20E through 20H coupled to the second power strip 8B may be coupled to one another via another communication line.

Thus, it is possible to reduce an electric current flowing through each of the two power supply paths separated at the outlet 6.

### 2-7. Supplementary Explanation

Two or more functions of one element in the aforementioned embodiments may be achieved by two or more elements, and one function of one element may be achieved by two or more elements. Furthermore, two or more functions of two or more elements may be achieved by one element, and one function achieved by two or more elements may be achieved by one element. A part of the configurations in the aforementioned embodiments may be omitted. Furthermore, at least a part of the configurations in the aforementioned embodiments may be added to or replaced by another configuration in the above-described embodiments.

What is claimed is:

1. A charger comprising:
a housing configured such that a battery pack is detachably attached thereto;
a charging circuit in the housing, the charging circuit being configured (i) to receive external power from an external power supply and (ii) to perform a charging operation to charge the battery pack attached to the housing based on the external power, the external power supply being outside the housing;
a communication device configured to communicate with a first external charger, the first external charger being outside the housing; and
a control circuit in the housing, the control circuit being configured to:
(i) control the charging circuit so as to put the charging operation of the charging circuit on hold, based on the battery pack being attached to the housing and the communication device having received a first charging notification from the first external charger; and
(ii) control the charging circuit such that the charging circuit initiates the charging operation, based on the battery pack being attached to the housing and the communication device not having received the first charging notification,
wherein the first charging notification is transmitted from the first external charger based on the first external charger transitioning or having transitioned to its charging operation.

2. The charger according to claim 1, wherein:
the communication device is configured to communicate with a second external charger in addition to the first external charger;
the second external charger is (i) distinct from the first charger and (ii) outside the housing;
the control circuit is configured to:
(i) control the charging circuit so as to put the charging operation of the charging circuit on hold, based on the battery pack being attached to the housing and the communication device having received the first charging notification and a second charging notification; and
(ii) control the charging circuit such that the charging circuit initiates the charging operation, based on the battery pack being attached to the housing and the communication device having received neither the first charging notification nor the second charging notification;
the second charging notification is transmitted from the second external charger based on the second external charger transitioning or having transitioned to its charging operation.

3. The charger according to claim 2, wherein:
the control circuit is configured to transmit a third charging notification from the communication device to the second external charger based on the communication device having received the first charging notification; and
the second external charger is configured to put its charging operation on hold based on a receipt of the third charging notification.

4. The charger according to claim 2, wherein:
the control circuit is configured to transmit a third charging notification from the communication device to the first external charger and to the second external charger when the control circuit controls the charging circuit such that the charging circuit initiates the charging operation; and
each of the first external charger and the second external charger is configured to put its charging operation on hold based on a receipt of the third charging notification.

5. The charger according to claim 4, wherein:
the control circuit is configured to:
(i) transmit the third charging notification from the communication device to the first external charger and to the second external charger and (ii) control the charging circuit so as to keep the charging operation of the charging circuit on hold, based on the battery pack being attached to the housing and the communication device having received neither the first charging notification nor the second charging notification; and
transmit a stop notification from the communication device to the first external charger based on the communication device having received the first charging notification by a lapse of a preset time period when the charging operation of the charging circuit is kept on hold; and
the first external charger is configured to transition to its charging operation based on a receipt of the stop notification.

6. The charger according to claim 5,
wherein the control circuit is configured to control the charging circuit such that the charging circuit initiates the charging operation, based on the communication device having received neither the first charging notification nor the second charging notification by the lapse of the preset time period.

7. The charger according to claim 1, further comprising
a notification device configured to notify a user of the charger that the charging operation of the charging circuit is on hold,
wherein the control circuit is configured to activate the notification device based on the control circuit controlling the charging circuit so as to put the charging operation of the charging circuit on hold.

8. The charger according to claim 1,
wherein the control circuit is configured to control the charging circuit such that the charging circuit initiates the charging operation based on the communication device not receiving the first charging notification when the charging operation of the charging circuit is on hold.

9. A charging system comprising
two or more chargers electrically coupled to a shared power supply path, each of the two or more chargers being configured to charge a battery pack, at least one of the two or more chargers being the charger according to claim 1, and the shared power supply path being configured to receive an external power from an external power supply.

10. A method for controlling two or more chargers, comprising:
electrically coupling the two or more chargers to a shared power supply path, the shared power supply path receiving an external power from an external power supply;
communicably coupling the two or more chargers to one another;
electrically coupling at least one battery pack to at least one charger of the two or more chargers for charging the at least one battery pack; and
transmitting a charging notification from one of the at least one charger to one or more remaining chargers of the two or more chargers to put charging operations of the one or more remaining chargers on hold.
